(19) United States
(12) Patent Application Publication
(10) Pub. No.: US 2022/0092638 A1
(43) Pub. Date: Mar. 24, 2022

(54) METHODS, SYSTEMS, AND DEVICES FOR ADJUSTING AN ADVERTISING CAMPAIGN BASED ON DYNAMIC ATTRIBUTION WINDOW AND TIME DECAY ESTIMATION

(71) Applicant: Xandr Inc., New York, NY (US)

(72) Inventors: Peter Willard Shankel, Sachse, TX (US); Bo Hong, Coppell, TX (US); Matthew Robert Teshera, Weehawken, NJ (US); Trevor Ross, Brooklyn, NY (US)

(73) Assignee: Xandr Inc., New York, NY (US)

(21) Appl. No.: 17/031,092

(22) Filed: Sep. 24, 2020

(51) Int. Cl. G06Q 30/02; G06F 17/18; G06N 20/00

(52) U.S. Cl. CPC G06Q 30/0244; G06Q 30/0246; G06Q 30/0269; G06Q 30/0205; G06Q 30/0261; H04N 21/812; G06Q 30/0272; G06F 17/18; G06N 20/00; G06Q 30/0267; G06Q 30/0264

(57) ABSTRACT

Aspects of the subject disclosure may include, for example, determining conversions associated with an advertising campaign, identifying consumers associated with the conversions. Further embodiments can include determining an attribution window for the advertising campaign, identifying first advertisements of the advertising campaign exposed to the consumers during the attribution window. Additional embodiments include identifying an advertising medium for each of the first advertisements resulting in a plurality of advertising mediums, and adjusting the advertising campaign according to the conversions and the plurality of advertising mediums resulting in an adjusted advertising campaign. Also, embodiments include delivering, over a communication network, second advertisements associated with the adjusted advertising campaign to communication devices associated with target households. A portion of the second advertisements is presented on each of the communication devices. Other embodiments are disclosed.

### FIELD OF THE DISCLOSURE

The subject disclosure relates to methods, systems, and devices for adjusting an advertising campaign based on dynamic attribution window and time decay estimation.

### BACKGROUND

An advertising attribution model is a decision support mechanism intended to help advertisers understand the way in which myriad of variables contribute to the conversion rate for an advertising campaign spanning a specific time period and targeting a specific group of consumers as prospective buyers. Further, conversion rate is a measure of the success of a given advertising campaign usually expressed as some measure of response attributed to the advertising. There are several types and approaches to attribution analysis in the current state of the art that include rules-based and model-based. Rules-based logic, such as first touch, last touch, positional and time decay largely arrive out of the digital advertising arena. Additionally, model-based attribution methods such as marketing mix modeling, consider the effects of marketing channels on outcomes (e.g., conversion rates) but fall short in delivering insight into the impact of advertising's myriad tools. Finally, multi-touch attribution seeks to bridge marketing mix modeling and the more common approaches leveraged in digital advertising to highlight the overall impact of advertising, marketing and influencers external to the firm like weather, competition, etc.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIGS. 2B-2G depicts illustrative embodiments of methods in accordance with various aspects described herein.

FIG. 2H depicts plots of an attribution windows for embodiments and methods described in FIGS. 2A-2G.

FIG. 2I is a block diagram illustrating an example, non-limiting embodiment of a system functioning within the communication network of FIG. 1 and FIG. 2A in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for determining a group of conversions associated with an advertising campaign, and identifying a group of consumers associated with the group of conversions. Further embodiments can include determining an attribution window for the advertising campaign, and identifying a first plurality of advertisements of the advertising campaign exposed to the group of consumers during the attribution window. Additional embodiments can include identifying an advertising medium for each of the first plurality of advertisements resulting in a first plurality of advertising mediums, and adjusting the advertising campaign according to the group of conversions, the first plurality of advertisements, and the first plurality of advertising mediums resulting in an adjusted advertising campaign. Also, embodiments can include delivering, over a communication network, a second plurality of advertisements associated with the adjusted advertising campaign to a group of communication devices associated with a group of target households. A portion of the second plurality of advertisements is presented on each of the group of communication devices.

One or more aspects of the subject disclosure include a device, comprising a processing system including a processor, and a memory that stores executable instructions that, when executed by the processing system, facilitate performance of operations. The operations can comprise determining a group of conversions associated with an advertising campaign, identifying a group of consumers associated with the group of conversions. Further operations can comprise determining an attribution window for the advertising campaign, and identifying a first plurality of advertisements of the advertising campaign exposed to the group of consumers during the attribution window. Additional operations can comprise identifying an advertising medium for each of the first plurality of advertisements resulting in a first plurality of advertising mediums, and adjusting the advertising campaign according to the group of conversions, the first plurality of advertisements, and the first plurality of advertising mediums resulting in an adjusted advertising campaign. Also, operations can comprise delivering, over a communication network, a second plurality of advertisements associated with the adjusted advertising campaign to a group of communication devices associated with a group of target households. A portion of the second plurality of advertisements is presented on each of the group of communication devices.

One or more aspects of the subject disclosure include a machine-readable medium, comprising executable instructions that, when executed by a processing system including a processor, facilitate performance of operations. The operations can comprise selecting a group of target households for an advertisement campaign, and determining demographics for each of the group of target households resulting in a group of demographics. Further operations can comprise determining media content viewed by each of the group of target households resulting in a group of media content, and generating the advertising campaign according to the group of target households, the group of demographics, and the group of media content. Additional operations can comprise determining a group of conversions associated with an advertising campaign, identifying a group of consumers associated with the group of conversions, and determining an attribution window for the advertising campaign. Also, operations can comprise identifying a first plurality of advertisements of the advertising campaign exposed to the group of consumers during the attribution window, and identifying an advertising medium for each of the first plurality of advertisements resulting in a first plurality of advertising mediums. Further operations can comprise adjusting the advertising campaign according to the group of conversions, the first plurality of advertisements, and the first plurality of advertising mediums resulting in an adjusted advertising campaign, and delivering, over a communication network, a second plurality of advertisements associated with the adjusted advertising campaign to a group of communication devices associated with a group of target households. A portion of the second plurality of advertisements is presented on each of the group of communication devices.

One or more aspects of the subject disclosure include a method. The method can comprise selecting, by a processing system including a processor, a group of target households for an advertisement campaign, and identifying, by the processing system, an amount of screen time for each advertising medium associated with each target household of the group of target households resulting in group of amounts of screen time. Further, the method can comprise determining, by the processing system, a group of conversions associated with the advertising campaign, and identifying, by the processing system, a group of consumers associated with the group of conversions. In addition, the method can comprise determining, by the processing system, an attribution window for the advertising campaign, identifying, by the processing system, a first plurality of advertisements of the advertising campaign exposed to the group of consumers during the attribution window. Also, the method can comprise identifying, by the processing system, an advertising medium for each of the first plurality of advertisements resulting in a first plurality of advertising mediums. The identifying of the advertising medium for each of the first plurality of advertisements resulting in the first plurality of advertising mediums comprises determining, by the processing system, the first plurality of advertising mediums according to the group of amounts of screen time. Operations can comprise adjusting, by the processing system, the advertising campaign according to the group of conversions, the first plurality of advertisements, and the first plurality of advertising mediums resulting in an adjusted advertising campaign. Further, the method can comprise delivering, by the processing system, over a communication network, a second plurality of advertisements to a group of communication devices associated with a group of target households. A portion of the second plurality of advertisements is presented on each of the group of communication devices.

Various ad insertion management techniques and/or devices can be utilized in conjunction with the embodiments described herein (e.g., line items, deals, auctions, business rule enforcement, yield policy enforcement, competitive separation enforcement, and others) such as described in U.S. patent application Ser. No. 16/560,666 filed Sep. 4, 2019 and entitled Content Management in Over-The-Top Services, and also described in U.S. application Ser. No. 16/870,098 filed May 8, 2020 and entitled “Method and Apparatus for Managing Deals of Brokers in Electronic Advertising”, the disclosures of which are hereby incorporated by reference herein in their entirety.

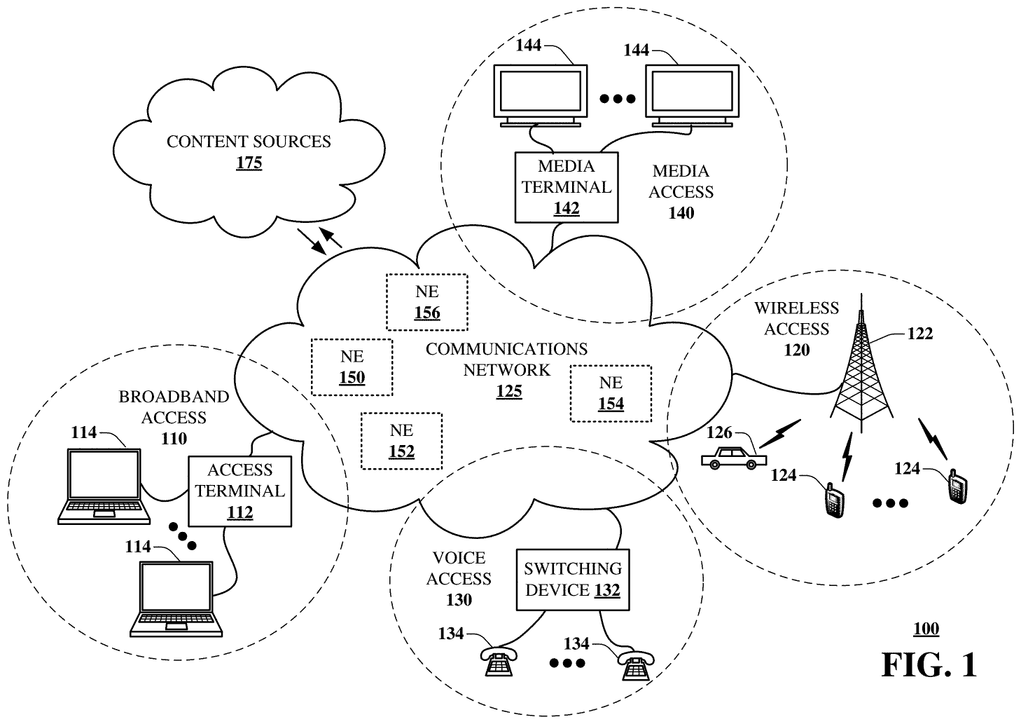

Referring now to FIG. 1, a block diagram is shown illustrating an example, non-limiting embodiment of a system 100 in accordance with various aspects described herein. For example, system 100 can facilitate in whole or in part determining a group of conversions associated with selected target households for an advertising campaign, determining the effectiveness of advertisements on consumers of the selected target households, and adjusting the advertising campaign to improve its effectiveness. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

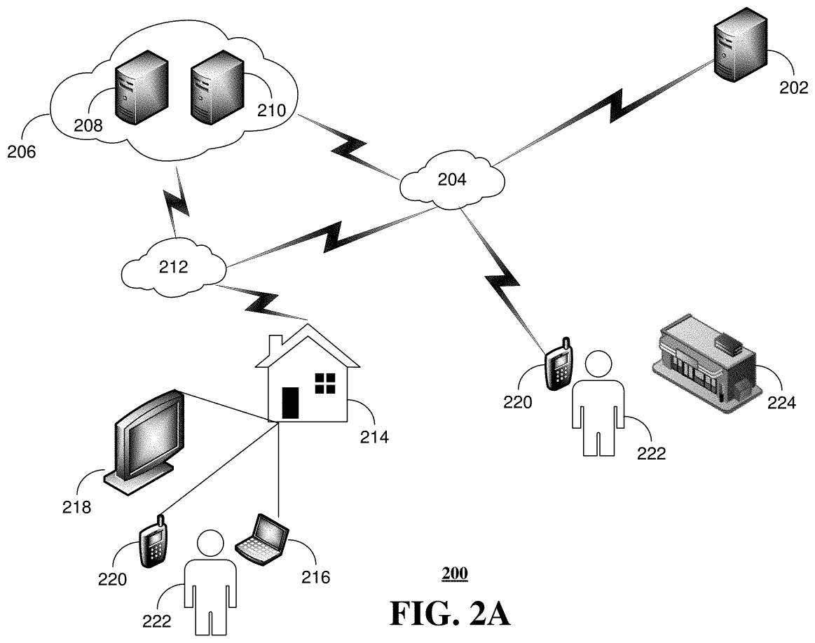

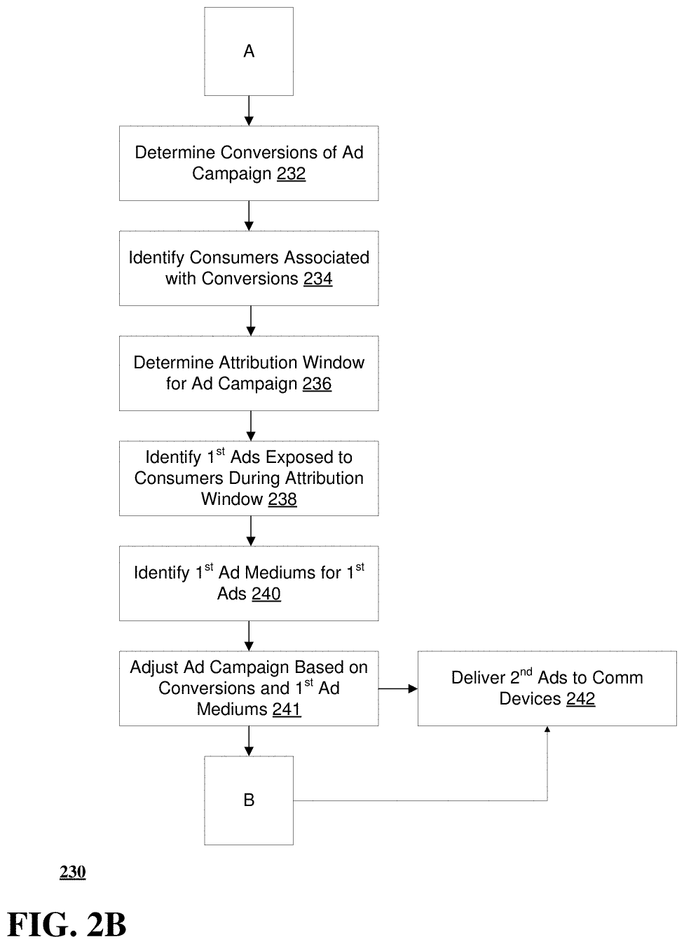

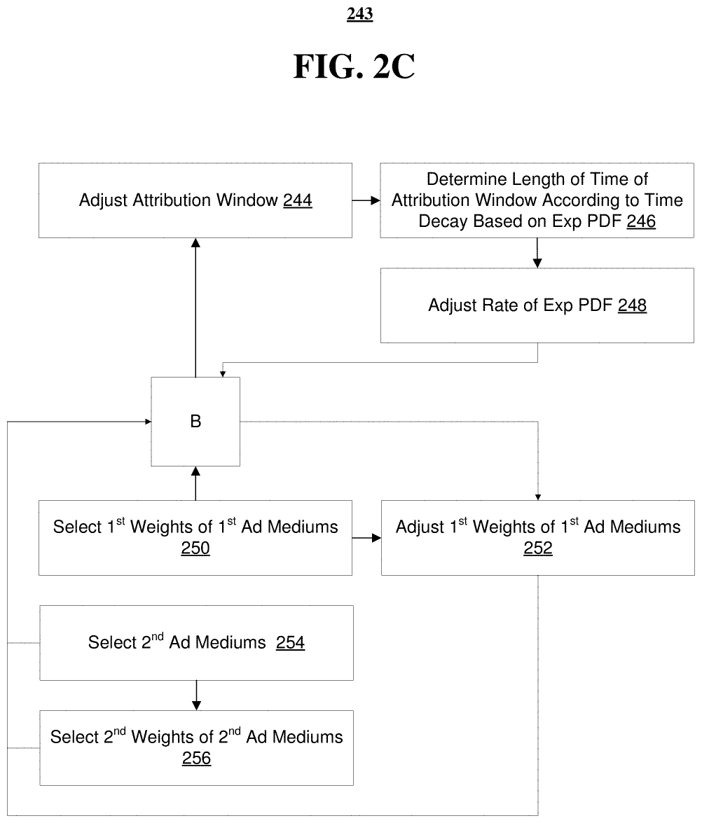

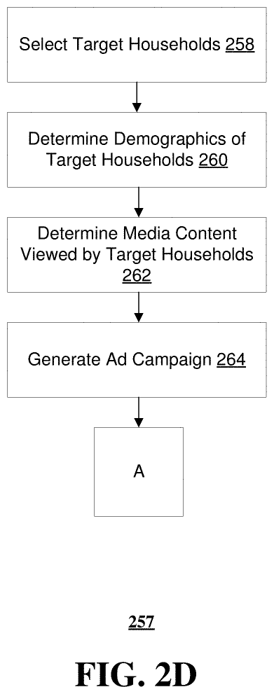

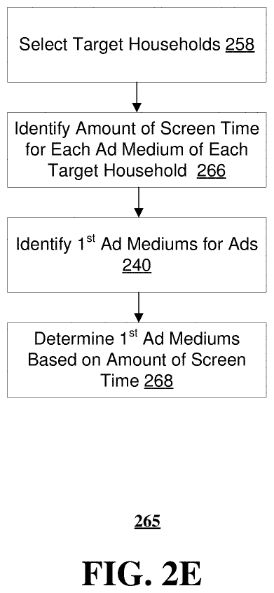

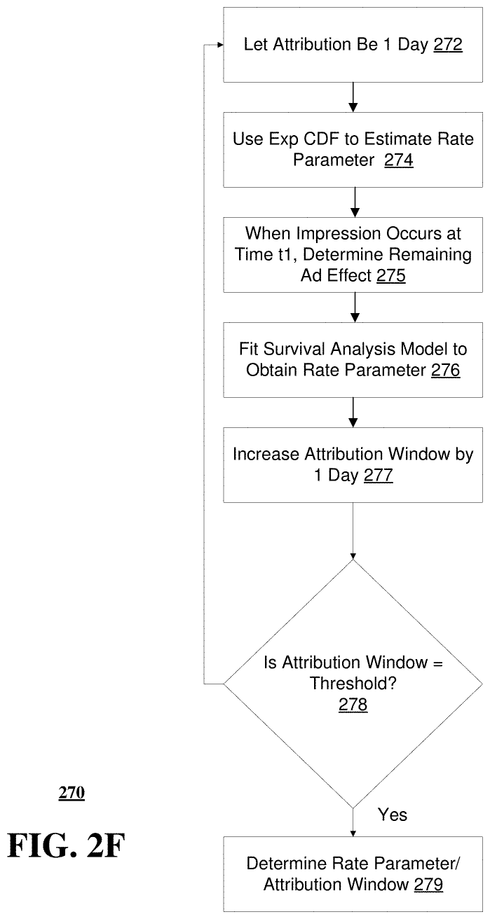

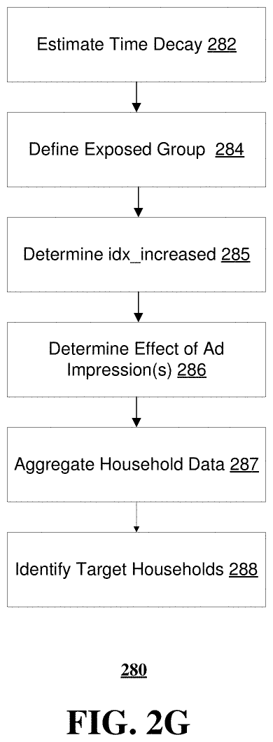

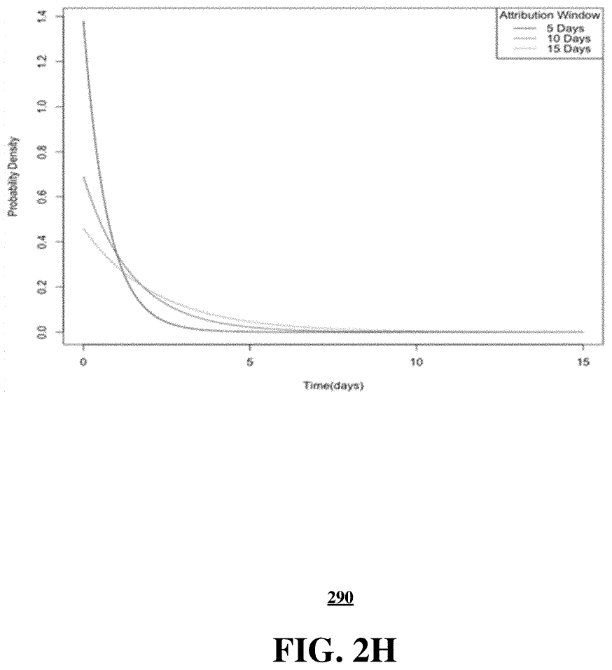

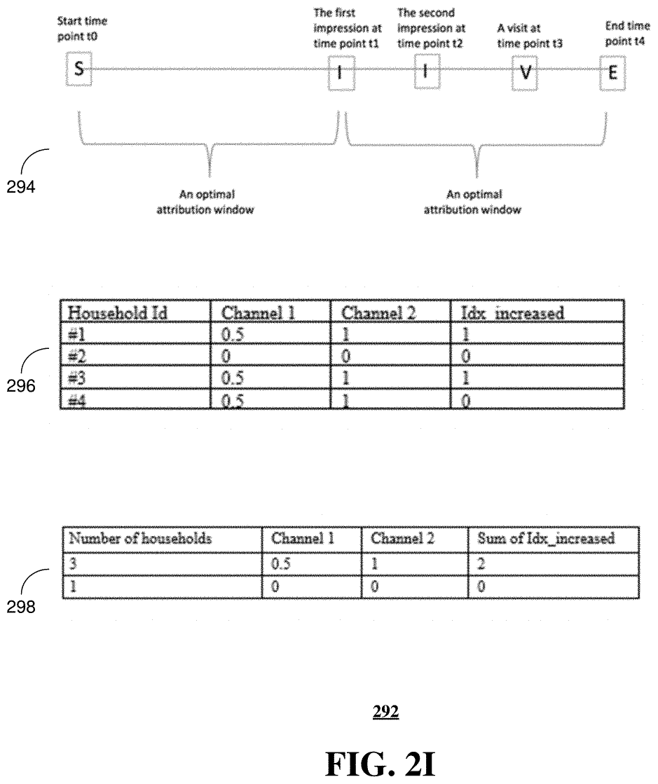

FIG. 2A is a block diagram illustrating an example, non-limiting embodiment of a system functioning within the communication network of FIG. 1 in accordance with various aspects described herein. In one or more embodiments, target advertising has become increasingly sophisticated in many situations including reaching household or a single consumer within a household. Given current state of target advertising, the measurement of advertising effectiveness needs to progress to provide meaningful insight. To that end, the advertising industry requires measurement tools that are both flexible with regard to examining input information used to develop an advertising campaign and based on elements of data science and artificial intelligence commensurate in sophistication with the target advertising methods such tools seek to measure. The embodiments that can be directed to improving the effectiveness of an advertising campaign can include an attribution (time) window, time based decay rate, and utilization of a machine learning framework. The attribution window represents a time frame in which incremental advertising yields incremental gains. Understanding the attribution window allows accurate assessment of both the trailing and cumulative impact of advertising on business results. A time based decay rate can be calculated dynamically and in concert with the attribution window to arrive at a time and rate of decay for a given advertising campaign. A machine learning framework designed to estimate the impact of each advertising element under examination as a mathematical equation within the aforementioned attribution window and time decay parameters. The three components of improving the effectiveness of an advertising campaign can work together to provide more valuable advertising insights and recommendations regarding where and how to place future advertising for similar products and services. With this approach, any combination of campaign elements can be examined simultaneously. The list of factors to develop an advertising campaign can include: advertising medium (e.g., mobile, desktop, television); network, channel or property; daypart; specific programs (if appropriate); demography; any other internal or exogenous variable, as long as it is measurable and available as input.

In one or more embodiments, an attribution window can be estimated for advertisements associated with an advertising campaign. In some embodiments, advertisers can use a set of heuristics wherein the attribution window is based on the period of time in which they believe impressions could lead to a conversion. This is typically referred to as the “lookback window,” or attribution window. The most common lookback window used is configured to be 14 days. In other embodiments, a methodology can include identifying an attribution window for advertising in which ad impressions provide increased conversions. In such embodiments, the attribution window can be a maximizing function based on the marginal return on advertising investment and is derived by estimating the point in time where the return on one additional day (or any other relevant unit of measure) of advertising no longer yields incremental gains in conversions. Advertising beyond this time window would yield a decrease in marginal returns realized as wasted advertising dollars. Thus, part of the practical application of the embodiments described herein is to adjust an advertising campaign by adjusting the attribution window, thereby providing benefits. That is, decreasing the attribution window in the adjusted advertising campaign can reduce advertising cost but maintain or even increase the effectiveness of the advertising campaign.

In one or more embodiments, time decay of the influence of advertisements of an advertising campaign on consumers can be estimated. Some embodiments can include a dynamically estimated approach to deriving the relative importance of each ad impression over time. Because the nature of an attribution window implies that an advertisement's impact diminishes over time, a measure of rate of time decay can be unique to the advertising campaign under examination and can be unique to the attribution window. In further embodiments, the relative importance of a given advertisement within the attribution window is assigned based on decision rules. However, the problem of adjusting time decay based on a dynamic attribution window can be considerably more complex than a set of fixed decision rules can accommodate. In particular, the field of econometrics highlights that each industry sector boasts a market response function while each competitor boasts a potentially unique sales response function. Accordingly, each product or service's sales response function may be unique as well. As a result, once a dynamic attribution window has been identified, then the matter of estimating time decay can be significant in making advertising recommendations via an attribution model.

One or more embodiments can include a machine learning framework. In some embodiments, a rules based approach to crediting a portion of a consumer's response (conversion) to a given advertising medium or element like a television network can be based on a simple compilation of impression frequency by advertising medium and/or the relative position in the attribution window. Examples of such methods are last touch and first touch, which deliver all the credit for a conversion to the last or first ad impression for a given consumer. Additional embodiments of the machine learning framework can be directed to consumer level data. Four elements have come to bear to create a data environment that foster great advances in the examination of advertising effectiveness and foster an opportunity to apply more sophisticated machine learning models to determine which advertising method can be effective. Elements coming together for form the nexus of this data opportunity include identity graphs, household level television viewership records, digital ad logs, and mobile location data. Identity graphs are capable of tracking ad impressions at the consumer and household level. Household level television viewership records are second by second viewing records that allow a granular view into the home. As a result, it can be inferred who is watching and who is responding to television ads. Digital ad logs deliver records of digital ad delivery that, when tied back via an identity graph, can be credited at the consumer level as well. Mobile location data grants a view into shopping and movement data, thereby enabling attribution of advertising impressions to offline shopping behavior at the consumer level.

Referring to FIG. 2A, in one or more embodiments, an advertising server 202 can be communicatively coupled over communication network 204 to cloud server 206 that can include media content servers 208, 210. Further, the cloud server 206 and media content servers 208, 210 can be communicatively coupled over communication network 212 to customer premises 214 (e.g., home, office, residence, commercial space, etc.) that is associated with a household. Further, the advertising server 202 can be communicatively coupled to the customer premises 214 over communication network 212 and communication network 204. Further, the customer premises 214 can include several different communication devices 216, 218, 220 associated with a consumer 222 that is associated with a household. Communication network 204 and communication network 212 can include a wireless communication network, a wired communication network, or a combination thereof. The communication devices 216, 218, 220 can include a media processor, a television, laptop computer, a desktop computer, a mobile device, a mobile phone, a tablet computer, a wearable device, or any other computing device.

In one or more embodiments, an advertising entity is attempting to measure the effectiveness of an advertising campaign. Further, an advertising campaign comprises a group of advertisements that are delivered to a group of communication devices of consumers within target households over different advertising mediums via a communication network. Measuring the effectiveness of an advertising campaign can be determined by detecting a consumer 222 visiting (e.g., conversions) a premises 224 associated with the advertising entity (e.g., store) and determining whether the consumer 222 was recently exposed to one of the group of advertisements in the advertising campaign within an attribution window. That is, the consumer 22 being exposed to an advertisement associated with the advertising entity over six months ago probably did not influence the consumer 222 to visit the premises 224 of the advertising entity. However, being exposed to multiple advertisements in the past week may have influenced the consumer 222 to visit the premises 224 of the advertising entity. Measuring the effectiveness of a current advertising campaign and adjusting the advertising campaign to improve its effectiveness is one of the technical problems addressed by the embodiments described herein. Further, measuring the effectiveness of an advertising campaign and adjusting the advertising campaign that can include adjusting of the attribution window and the group of advertising mediums can improve the effectiveness of the adjusted advertising campaign. Thus, in one or more embodiments, mathematical formulas that are used to determine the attribution window and the time decay of influence of an advertisement exposed to a consumer as well as the embodiments described herein, are integrated in a practical application of measuring effectiveness of a current advertising campaign and adjusting the advertising campaign to improve its effectiveness. That is, improving a likelihood that a consumer 222, exposed to advertisements of an advertising campaign will visit a premises 224 of the advertising entity.

In one or more embodiments, the advertising server 202 can generate an advertising campaign associated an advertising entity (e.g., company, manufacturer, etc.) that provides a product or service. The generating of the advertising campaign can include generating a group of advertisements associated with the product or service as well as selecting a group of target households to deliver the group of advertisements and selecting a group of advertising mediums in which to deliver a portion of the group of advertisements over one or more communication networks 204, 212. An advertising medium can include, but not limited to, a television channel that provides media content, streaming media content, playback of downloaded media content, a website, a mobile application, etc. The consumer 222 can view various media content on a communication device 216, 218, 220 and be provided a portion of the group of advertisements at the communication device 216, 218, 220 through one or more of the group of advertising mediums during an attribution window (e.g., time period).

In one or more embodiments, after being exposed to a portion or all of the group of advertisements in the advertising campaign, the consumer 222 can visit the premises 224 associated with the entity of the advertising campaign. The consumer 222 visit to the premises 224 can be called a conversion within the advertising campaign. That is, the exposure to a portion of the group of advertisements associated with the advertising campaign may have influenced the consumer 222 to visit premises 224, thereby possible purchasing a good or service offered by the advertising entity. The advertising server 202 can determine that the consumer 222 has visited premises 224 by detecting a location of mobile device 220 associated with the consumer 222 over communication network 204 and determining the location of the mobile device 220 is at or proximate to (within a distance threshold) the premises 224.

In one or more embodiments, the portion of the group of advertisements that are part of the advertising campaign for an entity can be distributed to a group of target households. The advertising server 202 can select a group of target households for the advertising campaign. Further, the advertising server can determine the demographics, preferred advertising mediums, media content, daypart, or any other variable in selecting the target households. Note, daypart is the process of dividing television, radio, or any other media broadcast into different blocks of times, or parts, and adjusting an advertising strategy based on the programming and demographics of the viewers. In addition, the advertising server 202 can obtain and determine the media content viewed by each of the group of target households (e.g., the consumers thereof) from the media content servers 208, 210. Also, the advertising server 202 can generate the advertising campaign according to the group of target households, demographics of target households, preferred advertising mediums of consumers within the group of target households, media content viewed by consumers within the target households, and/or the daypart associated with consumers of the target households.

In one or more embodiments, the advertising server 202 can obtain and identify from the media content servers 208, 210 an amount screen time for each advertising medium associated with each target household resulting in a group of amounts of screen time and identify the advertising mediums on which to deliver a portion of the group of advertisements of the advertising campaign over communication network 212 according to the group of amounts of screen time.

In one or more embodiments, the delivery of a portion of the group of advertisements associated with an advertising campaign can include the advertising server 202 providing, over communication network 204, the portion of the group of advertisements to media content server 208 and 210, then the media content servers 208, 210 can deliver each of the advertisements with media content over communication network 212 to communication devices 216, 218, 220. In some embodiments, an advertisement can be embedded into the media content provided by one of the media content servers 208, 210 or can be a banner advertisement presented on a website that is provided by one of the media content servers 208, 210. The delivery of the advertisements on different advertising medium by the media content server 208, 210 can be according to instructions provided by the advertising server 202 based on the preferences of advertising mediums for a consumer 222. In other embodiments, the advertising server 202 can deliver advertisements of the advertising campaign to communication devices 216, 218, 220 over communication network 204 and communication network 212 to present the advertisements over the preferred advertising mediums associated with the consumer 222. Preferred advertising mediums can include advertising mediums that are advertising mediums that are more effective in advertising to the consumer 222 than other advertising mediums.

In one or more embodiments, the advertising server 202 can determine a group of conversions associated with the advertising campaign. Further, the advertising server 202 can identify a group of consumers associated with the group of conversions. In addition, the advertising server 202 can determine an attribution window for the advertising campaign. In addition, the advertising server 202 can identify a first plurality of advertisements of the advertising campaign exposed to the group of consumers during the attribution window. Also, the advertising server 202 can identify an advertising medium for each of the first plurality of advertisements resulting in a first plurality of advertising mediums. Further, the advertising server 202 can adjust the advertising campaign according to the group of conversions, the first plurality of advertisements, and first plurality of advertising mediums resulting in an adjusted advertising campaign. In addition, the advertising server can deliver, over communication network 204 and/or communication network 212 (an in some embodiments via media content server 208 or media content server 210), a second plurality of advertisements associated with the adjusted advertising campaign to a group of communication devices 216, 218, 220 associated with a group of target households. A portion of the second plurality of advertisements is presented on each of the group of communication devices 216, 218, 220.

In one or more embodiments, the adjusting of the advertising campaign comprises adjusting the attribution window by the advertising server 202. Further, the advertising server 202 can determine a length of time for the attribution window according to a time decay of an affect of an advertisement on a consumer 222. The time decay is based on an exponential probability distribution function (or cumulative distribution function). In addition, the adjusting of the attribution window comprises adjusting a rate of the exponential probability distribution function by the advertising server 202.

In one or more embodiments, the advertising server 202 can select a first weight for each of the first plurality of advertising mediums. Advertising mediums may be weighted as part of generating or adjusting an advertising campaign to take into account the effectiveness of one type of advertising medium over another type of advertising medium. That is, the amount of screen time of consumer 222 can be 25% associated with television 218 off which is streaming media content, 25% associated with laptop computer 216 all of which is web browsing, and 50% associated with mobile phone 220 40% out of the 50% of which is streaming media content and 10% out of the 50% of which is web browsing. Thus, the group of advertisements presented to the consumer 222 are separated onto different advertising mediums (e.g., television, websites, streaming media content) based on weights according to amount of screen time such that 40% (i.e., weight) of the group of advertisements are provided with streaming media content (i.e., advertising medium), 25% (i.e., weight) of the group of advertisements are provided with a television broadcast (i.e., advertising medium), and 35% (i.e., weight) of the group of advertisements are presented on websites to the consumer 222. Further, the adjusting the advertising campaign can comprise adjusting the first weight for each of the first group of advertisements mediums by the advertising server 202. That is, in can be determined that advertisements presented on the websites are have little influence on the consumer 222 to visit premises 224 but advertisements presented during a television broadcast or with streaming media content do so. Thus, the weights for each of the advertising mediums can be adjusted from 40% for streaming content, 25% for television broadcast, and 35% for websites to 55% streaming media content, 40% for television broadcast, and 5% for websites, for example. In addition, the advertising server 202 can select the first plurality of advertising mediums. The adjusting of the advertising campaign can comprise selecting a second plurality of advertising mediums by the advertising server 202. Also, the adjusting of the advertising campaign comprises selecting a second weight for each of the second plurality of advertising mediums by the advertising server 202. That is, it can be determined that advertisements presented on the websites are have little influence on the consumer 222 to visit premises 224 but advertisements presented during a television broadcast or with streaming media content does so. Thus, the second plurality of advertising mediums can only include television broadcast and streaming media content such that the weights are 60% streaming media content and 40% for television broadcast, for example.

The advertising server 202, cloud servers 206, and media content servers 208, 210 can be one server, a group of servers, a virtual server, or a group of virtual servers, the functions of which are spread across a group of computing devices.

One or more embodiments can include a model for cross screen attribution and conversion analytics based on estimating the impact of advertising over time according to dynamic attribution window estimation and dynamic time decay estimation combined with a machine learning framework.

Referring to FIG. 2F, in one or more embodiments, survival analysis can be used to identify or estimate an attribution window. An advertising server can be used to implement the method 270 to identify or estimate the attribution window. The method 270 can include the advertising server, at step 272, letting attribution window be one day. The start time of attribution window can be the start time of each campaign. The method 270 considers all of the impressions (i.e., advertisements that are exposed to a consumer) and visits (e.g., conversions) within the attribution window. If no visit occurs during the attribution window, then the method 270 includes all of the impressions in the attribution window. If any visit occurs, the method 270 includes the first visit and all of the impressions that led up to the first visit in the attribution window. Further, method 270 can include the advertising server 202, at 274, estimating the rate parameter of the attribution window by determining that the amount of time (in days) an ad effect lasts that follows an exponential distribution with the rate parameter λ. The method 20 can use the cumulative distribution function (CDF) of the attribution window to estimate the rate parameter λ by solving the following equation:

1−exp(−λ*the attribution window)=0.999

IF an ad effect diminishes after the attribution window, the CDF of the attribution window will be approximately be 1. The method 270 can denote the estimate of λ by \hat{λ}. In addition, the method 270 can include the advertising server 202, at 275, when an impression occurs at time point t1, determining the remaining ad effect at time point t2, due to ad decay, which can be exp(−\hat{λ}*(t2−t1)). At each time point of impression, the ad stock can be the sum of the remaining ad effect from all the previous impressions. Also, the method 270 can include the advertising server 202, at 276, fitting a survival analysis model using the ad stock (from previous step 275) as time dependent covariate. Further, the method 270 can obtain the exponent of the coefficient. Further, the method 270 can include the advertising server 202, at 277, increasing the attribution window by 1 day and repeating steps 272-277 until the attribution window meets a predefined threshold, for example, 20 days, at 278. In addition, the method 270 can include the advertising server 202, at 278, determining the rate parameter and/or attribution window. Often, the coefficients of survival analysis for the first few iterations of the attribution window are not statistically significant. Beginning with the attribution window for which the coefficient of the survival analysis is statistically significant, the method 270 can identify the one with the largest coefficient for estimating the attribution window for the advertising campaign.

Referring to FIG. 2G, in one or more embodiments, to assign credit for conversion rate to different variables such as advertising mediums and demographic data, negative binomial regression model with regularization is used. An advertising server can be used to implement the method 280 to determining attribution modeling using a machine learning framework with dynamically estimated attribution and dynamic estimation of time decay. The method 280 can include the advertising server, at 282, estimating the time decay. The amount of time (in days) an ad effect lasts follows an exponential distribution with the rate parameter λ. Given the calculated attribution window (the number of days) above, estimate the parameter λ of the following equation:

1−exp(−λ*the attribution window)=0.999

Denote the estimate of λ by \hat{λ}. The plots 290 in FIG. 2H show the probability density function based on three different attribution windows. Notice that larger attribution window leads to slower ad decay rate. Further, the method 280 can include the advertising server, at 284, defining the exposed group. Defining the exposed group, can refer to households that are exposed to advertisements during the advertising campaign. The method 280 can also define the non-exposed group, which refers to households that are not exposed to any advertisements during the advertising campaign. In addition, the method 280 can include the advertising server, at 285, determining increase in the number of visits (idx_increased). Denote all the first impression occurring times from the exposed group by T={t1, t1, . . . , tn}. Randomly assign each ti in T to households of the non-exposed group. Then at each ti, calculate the difference in the number of visits during the attribution window (defined in step 282) after and before ti. Similarly, at each ti in T, for each household in the exposed group, calculate the difference in the number of visits during the attribution window after and before ti. A variable, idx_increased, is defined as for each household. If the calculated difference in visits is less than or equal to 0, set idx_increased=0; otherwise, set idx_increased=1. Also, the method 280 can include the advertising server, at 286, determining the effect of advertisement impression(s). In the exposed group, for each household, the method 280 can consider all of the impressions and visits within the attribution window after the first impression. If no visits occur, the method 280 can record the time points of all of the impressions (within the attribution window) for further analysis. If any visits occur, record the time points of the first visit and all of the impressions before the first visit. Then the method 280 can include calculating the effect of each recorded impression within the attribution window through the CDF of t: 1−exp(−\hat{λ}*t), where t is the time difference between the time point of an impression and the end time point of the optimal attribution window. The axis line graph 294 in FIG. 2I shows how to calculate the effect of impression for a household's data. Further, the axis line graph 294 of FIG. 2I can be described as follows. Suppose ads were placed on channel 1 (e.g., first advertising medium) and channel 2 (e.g., second advertising medium). Idx_increased=1 because the difference in visit is 1−0=1. The effect of the first impression is 1 over the attribution window. The effect of the second impression only covers time period t4−t2, therefore the effect of the second impression is 1−exp(−\hat{λ}*(t4−t2)). If the first impression is on channel 1 and the second is on channel 2, then the effect of impressions on channel 1 is 1 and on channel 2 is 1−exp(−\hat{λ}*(t4−t2)). If both of the impressions are on channel 1, then the effect of impressions on channel 1 is 1+1−exp(−\hat{λ}*(t4−t2)) and on channel 2 is 0. Further, calculate the effect of impressions for each household in the exposed group. For each household in the non-exposed group, all the effect of impressions is 0. Table 296 in FIG. 2I contains the data for four unique households who were exposed to two channels. Referring back to FIG. 2G, the method 280 can include the advertising server, at 287, aggregating household data. This can include combining all the data from both the exposed group and the non-exposed group. The method 280 can group the data by the values of channel 1 and channel 2, calculate the sum of idx_increased and the count of the households in the group. For example, from table 296 of FIG. 2I, table 298 of FIG. 2I can be obtained. Because in table 296 there are 3 households with the same values of Channel 1 and Channel 2, they are aggregated into one row in table 298. Also, table 296 shows that among the 3 households, only 2 households are converted (with idx_increased=1), so the corresponding sum of idx_increased in table 298 is 2. Further, the method 280 can include the advertising server, at 288, identifying target households. Channel 1 and Channel 2 are an example for independent variables in tables 296 and 298. Any other variables such as demographic data or interaction between variables can be included in the analysis. In addition, the method 280 can include fitting a negative binomial regression model with or without regularization. Use the coefficient of each variable to assign credit for conversions and help identify target households in the adjusting of the advertising campaign.

FIGS. 2B-2E depicts illustrative embodiments of methods in accordance with various aspects described herein. Referring to FIG. 2B, in one or more embodiments, an advertising server can be used to implement the method 230. The method 230 can include the advertising server, at 232, determining a group of conversions associated with an advertising campaign. Further, the method 230 can include the advertising server, at 234, identifying a group of consumers associated with the group of conversions. In addition, method 230 can include the advertising server, at 236, determining an attribution window for the advertising campaign. Also, method 230 can include the advertising server, at 238 identifying a first plurality of advertisements of the advertising campaign exposed to the group of consumers during the attribution window. Further, method 230 can include the advertising server, at 240, identifying an advertising medium for each of the first plurality of advertisements resulting in a first plurality of advertising mediums. In addition, method 230 can include the advertising server, at 241, adjusting the advertising campaign according to the group of conversions, the first plurality of advertisements, and/or the first plurality of advertising mediums. In some embodiments, the adjusting of the advertising campaign can be according to a first portion of the plurality of advertisements exposed to the consumers and/or a second portion of the first plurality of advertisements not exposed to the consumers. The method 230 can include the advertising server, at 242, delivering, over a communication network, a second plurality of advertisements associated with the adjusted advertising campaign to a group of communication devices associated with a group of target households. A portion of the second plurality of advertisements is presented on each of the group of communication devices. Note, block A in FIG. 2B indicates that there may be some steps in methods shown in FIGS. 2D and 2E that can be implemented prior to step 232 and block B in FIG. 2B indicates that there may be some steps in the method shown in FIG. 2C that can be implemented after (or in conjunction with) step 241 and prior to step 242.

Referring to FIG. 2C, in one or more embodiments, an advertising server can be used to implement the method 243. The method 243 can include the advertising server, at 244, adjusting the attribution window. In some embodiments, the attribution window can be adjusted as described when discussing methods 270 and 280 described herein. In other embodiments, the adjusting of the advertising campaign comprises adjusting the attribution window. Further, the method 243 can include the advertising server, at 246, determining a length of time for the attribution window according to a time decay of an affect of an advertisement on a consumer of the group of consumers. The time decay can be based on an exponential probability distribution function. In addition, the method 243 can include the advertising server, at 248, adjusting a rate of the exponential probability distribution function. In further embodiments, the adjusting of the attribution window comprises adjusting a rate of the exponential probability distribution function.

In one or more embodiments, the method 243 can include the advertising server, at 250, selecting a first weight for each of the first plurality of advertising mediums. The selection of the first weight for each of the first plurality of advertising mediums can be performed after or while generating the advertising campaign. Further, the method 243 can include the advertising server, at 252, adjusting the first weight for each of the first plurality of advertisements mediums. In some embodiments, the adjusting the advertising campaign comprises adjusting the first weight for each of the first plurality of advertisements mediums.

In one or more embodiments, the method 243 can include the advertising server, at 254, selecting a second plurality of advertising mediums. In some embodiments, the adjusting of the advertising campaign comprising selecting a second plurality of advertising mediums. Further, the method 243 can include the advertising server, at 256, selecting a second weight for each of the second plurality of advertising mediums. In additional embodiments, the adjusting of the advertising campaign comprises selecting a second weight for each of the second plurality of advertising mediums.

Referring to FIG. 2D, in one or more embodiments, an advertising server can be used to implement the method 257. The method 257 can include the advertising server, at 258, selecting a group of target households for the advertising campaign. In some embodiments, the selection of the target households can be according to the method 280 described herein. Further, the method 257 can include the advertising server, at 260, determining demographics for each of the group of target households resulting in a group of demographics. In addition, the method 257 can include the advertising server, at 262, determining media content viewed by each of the group of target households resulting in a group of media content. Also, the method 257 can include the advertising server, at 264, generating the advertising campaign according to the group of target households, group of demographics, and group of media content.

Referring to FIG. 2E, in one or more embodiments, an advertising server can be used to implement the method 265. The method 265 can include the advertising server, at 258, selecting a group of target households for the advertising campaign. In some embodiments, the selection of the target households can be according to the method 280 described herein. Further, the method 265 can include the advertising server, at 266, identifying an amount of screen time for each advertising medium associated with each target household of the group of target households resulting in group of amounts of screen time. In addition, the method 265 can include the advertising server, at 240, the identifying of the advertising medium for each of the plurality of advertisements resulting in the first plurality of advertising mediums. Also, the method 265 can include the advertising server, at 268, determining the first plurality of advertising mediums according to the group of amounts of screen time. In some embodiments, the identifying of the advertising medium for each of the plurality of advertisements resulting in the first plurality of advertising mediums comprises determining the first plurality of advertising mediums according to the group of amounts of screen time.

In one or more embodiments, the first plurality of advertisements mediums comprises one of television channel, website on a computing device, streaming media content on a computing device, website on a mobile computing device, or streaming media content on a mobile computing device. Further, a conversion of the group of conversions comprises a consumer visit to a premises of an entity associated with the advertising campaign. Further, the advertising server can detect each of the group of conversions by detecting a location of a mobile device of a consumer associated with each of the group of conversions.

While for purposes of simplicity of explanation, the respective processes are shown and described as a series of blocks in FIGS. 2B-2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Further, any block can be implemented in response to another block in any of the blocks shown in FIGS. 2B-2F.

Portions of some embodiments can be combined with portions of other embodiments.

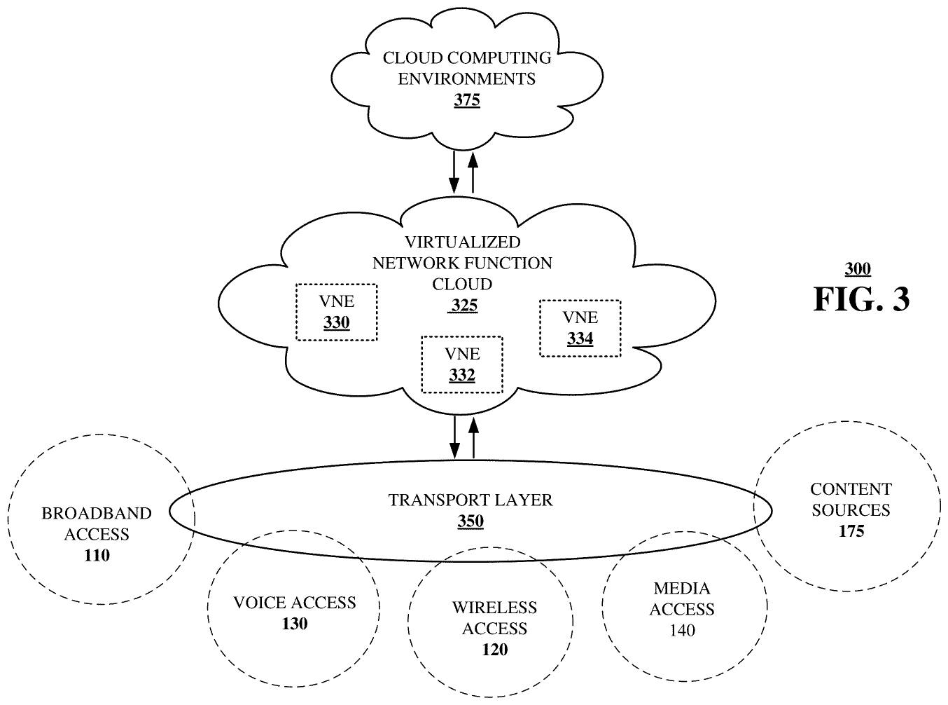

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and methods 230, 243, 257, 265, 270, 280 presented in FIGS. 1, 2A, 2B-2G, and 3. For example, virtualized communication network 300 can facilitate in whole or in part determining a group of conversions associated with selected target households for an advertising campaign, determining the effectiveness of advertisements on consumers of the selected target households, and adjusting the advertising campaign to improve its effectiveness.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

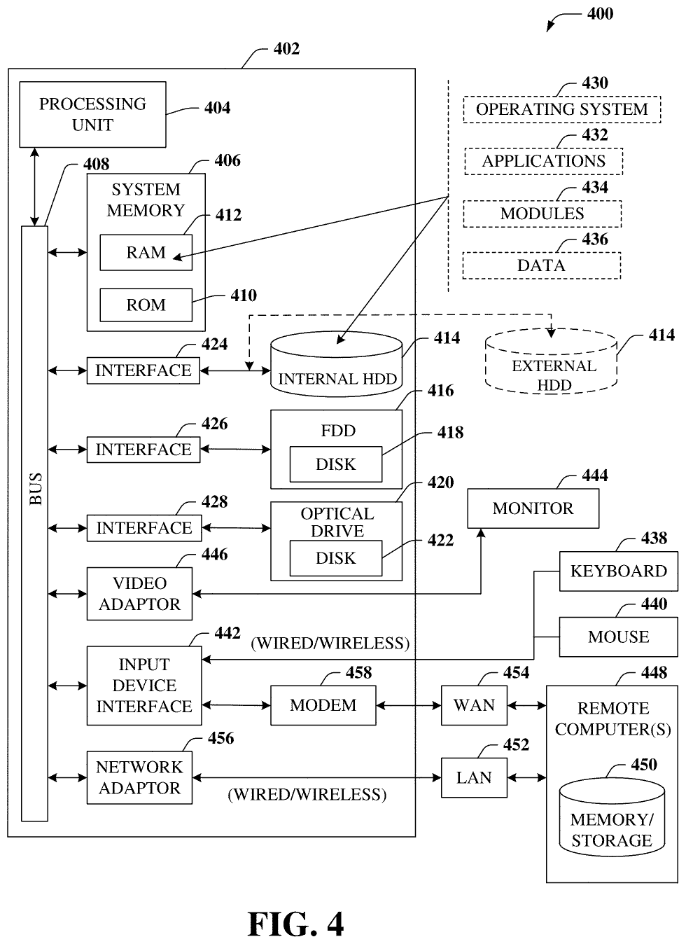

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part determining a group of conversions associated with selected target households for an advertising campaign, determining the effectiveness of advertisements on consumers of the selected target households, and adjusting the advertising campaign to improve its effectiveness. Further, each of the communication devices and servers shown in FIG. 2A comprise the computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

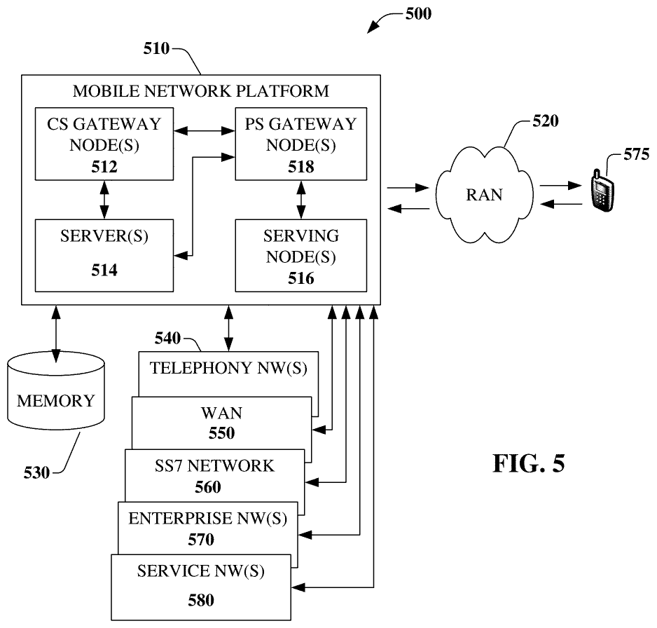

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part determining a group of conversions associated with selected target households for an advertising campaign, determining the effectiveness of advertisements on consumers of the selected target households, and adjusting the advertising campaign to improve its effectiveness. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

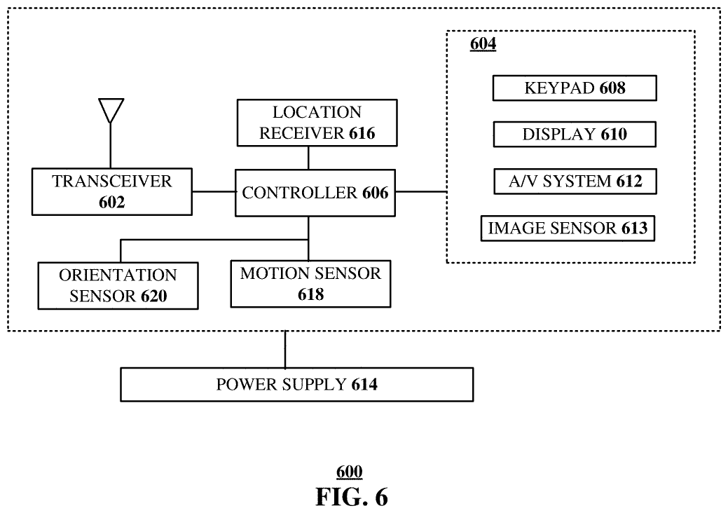

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part determining a group of conversions associated with selected target households for an advertising campaign, determining the effectiveness of advertisements on consumers of the selected target households, and adjusting the advertising campaign to improve its effectiveness. Further, each of the communication devices and servers shown in FIG. 2A comprise the computing device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
obtaining a location for each of a group of mobile devices resulting in a group of locations;
identifying each location of the group of locations is associated with a premises of an entity resulting in a group of identifications;
determining a group of conversions associated with an advertising campaign of the entity based on the group of identifications;
identifying a group of consumers associated with the group of conversions;
determining an attribution window for the advertising campaign;
identifying a first plurality of advertisements of the advertising campaign exposed to the group of consumers during the attribution window;
identifying an advertising medium for each of the first plurality of advertisements resulting in a first plurality of advertising mediums;
adjusting the advertising campaign according to the group of conversions, the first plurality of advertisements, and the first plurality of advertising mediums resulting in an adjusted advertising campaign; and
delivering, over a communication network, a second plurality of advertisements associated with the adjusted advertising campaign to a group of communication devices associated with a group of target households, wherein a portion of the second plurality of advertisements is presented on each of the group of communication devices.

2. The device of claim 1, wherein the adjusting of the advertising campaign comprises adjusting the attribution window.

3. The device of claim 2, wherein the operations comprise determining a length of time for the attribution window according to a time decay of an affect of an advertisement on a consumer of the group of consumers, wherein the time decay is based on an exponential probability distribution function.

4. The device of claim 3, wherein the adjusting of the attribution window comprises adjusting a rate of the exponential probability distribution function.

5. The device of claim 1, wherein the operations comprise selecting a first weight for each of the first plurality of advertising mediums.

6. The device of claim 5, wherein the adjusting the advertising campaign comprises adjusting the first weight for each of the first plurality of advertisements mediums.

7. The device of claim 1, wherein the operations comprise selecting the first plurality of advertising mediums, wherein the adjusting of the advertising campaign comprising selecting a second plurality of advertising mediums.

8. The device of claim 7, wherein the adjusting of the advertising campaign comprises selecting a second weight for each of the second plurality of advertising mediums.

9. The device of claim 1, wherein the first plurality of advertisements mediums comprises one of television channel, website on a computing device, streaming media content on a computing device, web site on a mobile computing device, or streaming media content on a mobile computing device.

10. The device of claim 1, wherein a conversion of the group of conversions comprises a consumer visit to the premises of the entity associated with the advertising campaign.

11. The device of claim 1, wherein the identifying of the advertising medium for each of the first plurality of advertisements resulting in the first plurality of advertising mediums comprises identifying a television advertising medium for each of a first portion of the first plurality of advertisements resulting in a plurality of television advertising mediums and identifying a mobile advertising medium for each of a second portion of the first plurality of advertisements resulting in a first plurality of mobile advertising mediums, wherein the adjusting of the adverting campaign comprises adjusting the advertising campaign according to the plurality of television advertising mediums and the first plurality of advertising mediums, wherein the delivering of the second plurality of advertisements comprises delivering the second plurality of advertisements over a second plurality of mobile advertising mediums.

12. The device of claim 1, wherein the operations comprise selecting the group of target households for the advertising campaign.

13. The device of claim 12, wherein the operations comprise:
determining demographics for each of the group of target households resulting in a group of demographics;
determining media content viewed by each of the group of target households resulting in a group of media content; and
generating the advertising campaign according to the group of target households, the group of demographics, and the group of media content.

14. The device of claim 12, wherein the operations comprise identifying an amount of screen time for each advertising medium associated with each target household of the group of target households resulting in a group of amounts of screen time, wherein the identifying of the advertising medium for each of the first plurality of advertisements resulting in the first plurality of advertising mediums comprises determining the first plurality of advertising mediums according to the group of amounts of screen time.

15. A non-transitory, machine-readable medium, comprising executable instructions that, when executed by a processing system including a processor, facilitate performance of operations, the operations comprising:
selecting a group of target households for an advertisement campaign;
determining demographics for each of the group of target households resulting in a group of demographics;
determining media content viewed by each of the group of target households resulting in a group of media content;
generating the advertising campaign according to the group of target households, the group of demographics, and the group of media content;
obtaining a location for each of a group of mobile devices resulting in a group of locations;
identifying each location of the group of locations is associated with a premises of an entity resulting in a group of identifications;
determining a group of conversions associated with the advertising campaign of the entity based on the group of identifications;
identifying a group of consumers associated with the group of conversions;
determining an attribution window for the advertising campaign;
identifying a first plurality of advertisements of the advertising campaign exposed to the group of consumers during the attribution window;
identifying an advertising medium for each of the first plurality of advertisements resulting in a first plurality of advertising mediums;
adjusting the advertising campaign according to the group of conversions, the first plurality of advertisements, and the first plurality of advertising mediums resulting in an adjusted advertising campaign; and
delivering, over a communication network, a second plurality of advertisements associated with the adjusted advertising campaign to a group of communication devices associated with the group of target households, wherein a portion of the second plurality of advertisements is presented on each of the group of communication devices.

16. The non-transitory, machine-readable medium of claim 15, wherein the adjusting of the advertising campaign comprises adjusting the attribution window.

17. The non-transitory, machine-readable medium of claim 16, wherein the operations comprise determining a length of time for the attribution window according to a time decay of an affect of an advertisement on a consumer of the group of consumers, wherein the time decay is based on an exponential distribution function.

18. The non-transitory, machine-readable medium of claim 17, wherein the adjusting of the attribution window comprises adjusting a rate of the exponential distribution function.

19. A method, comprising:
selecting, by a processing system including a processor, a group of target households for an advertisement campaign;
identifying, by the processing system, an amount of screen time for each advertising medium associated with each target household of the group of target households resulting in a group of amounts of screen time;
obtaining, by the processing system, a location for each of a group of mobile devices resulting in a group of locations;
identifying, by the processing system, each location of the group of locations is associated with a premises of an entity resulting in a group of identifications;
determining, by the processing system, a group of conversions associated with the advertising campaign of the entity based on the group of identifications;
identifying, by the processing system, a group of consumers associated with the group of conversions;
determining, by the processing system, an attribution window for the advertising campaign;
identifying, by the processing system, a first plurality of advertisements of the advertising campaign exposed to the group of consumers during the attribution window;
identifying, by the processing system, an advertising medium for each of the first plurality of advertisements resulting in a first plurality of advertising mediums wherein the identifying of the advertising medium for each of the first plurality of advertisements resulting in the first plurality of advertising mediums comprises determining, by the processing system, the first plurality of advertising mediums according to the group of amounts of screen time;
adjusting, by the processing system, the advertising campaign according to the group of conversions, the first plurality of advertisements, and the first plurality of advertising mediums resulting in an adjusted advertising campaign; and
delivering, by the processing system, over a communication network, a second plurality of advertisements associated with the adjusted advertising campaign to a group of communication devices associated with the group of target households, wherein a portion of the second plurality of advertisements is presented on each of the group of communication devices.

20. The method of claim 19, wherein the adjusting of the advertising campaign comprises adjusting, by the processing system, the advertising campaign according to the group of conversions, the first plurality of advertisements, and the first plurality of advertising mediums utilizing machine learning.
